(19) United States
(12) Patent Application Publication
(10) Pub. No.: US 2007/0075558 A1
(43) Pub. Date: Apr. 5, 2007

(54) CONSOLE ASSEMBLY FOR A VEHICLE

(75) Inventors: Won Tai Kim, Macomb, MI (US); Jason Gamache, Romeo, MI (US); Jerome David Joler, Rochester Hills, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/163,000

(22) Filed: Sep. 30, 2005

(51) Int. Cl. B60R 7/04

(52) U.S. Cl. 296/24.34

(57) ABSTRACT

A console assembly for use in a passenger seating area of a vehicle includes a console housing defining a storage area therein. An armrest is adjustably positioned relative to the console housing and is movable between a lowered position disposed at least partially adjacent the console housing compartment and a raised position disposed away from the console housing. One or more storage modules are disposed at least partially within the storage area and configured to receive and secure one or more items. The one or more storage modules are positionable between a stowed position and a deployed position extending at least partially through a channel cooperating with the storage area in the rear surface of the console housing.

### BACKGROUND OF THE INVENTION

1. Field of the Invention

The present invention relates generally to a console assembly for a passenger seating area of a vehicle.

2. Background Art

Vehicle manufacturers continue to develop storage containers and devices for the passenger compartments of vehicles to accommodate occupant's personal items and automotive components. Several current storage containers are designed to fit within specified areas of the passenger compartment and allow limited access to items stored therein.

Many automotive vehicles include a center console or other storage device disposed between the driver and passenger seats in the front passenger compartment of the vehicle. These consoles typically comprise a console base either secured to the floor or pivotally connected between the seats, a storage cavity formed in the console base to retain items during travel and an armrest pivotally connected to the console base extending generally horizontally across the storage cavity.

It would be advantageous to provide a storage console assembly for a vehicle which offers a wide variety of storage options while allowing access to items stored therein to most occupants of the vehicle.

### SUMMARY OF THE INVENTION

The present invention provides a console assembly for use in a passenger seating area of a vehicle. The console assembly includes a console housing having a base securable to a vehicle floor, a front surface, opposing side surfaces, a rear surface and a storage area defined therein. The console housing may be disposed between a pair of passengers seats in the front portion of the passenger seating area.

An armrest is adjustably positioned relative to the console housing and is movable between a lowered position disposed at least partially adjacent the console housing compartment and a raised position disposed away from the console housing. One or more storage modules are disposed at least partially within the storage area and configured to receive and secure one or more items.

The one or more storage modules are positionable between a stowed position and a deployed position extending at least partially through a channel cooperating with the storage area in the rear surface of the console housing. In the deployed position, the one or more storage modules are generally accessible by occupants in a rear portion of the passenger seating area of the vehicle.

Other features and advantages of the present invention will be readily appreciated and better understood after reading the subsequent description when considered in connection with the accompanying drawings.

### BRIEF DESCRIPTION OF THE DRAWINGS

FIG. 1 is a rear perspective view of a console assembly for a passenger seating area of a vehicle in accordance with the present invention;

FIG. 2 is a front perspective view of the console assembly;

FIG. 3 is a front perspective view of the console assembly with the armrest pivoted upward to allow access to the console storage area; and

FIG. 4 is a cross-sectional view of the console assembly along line 4—4 of FIG. 3 in accordance with the present invention.

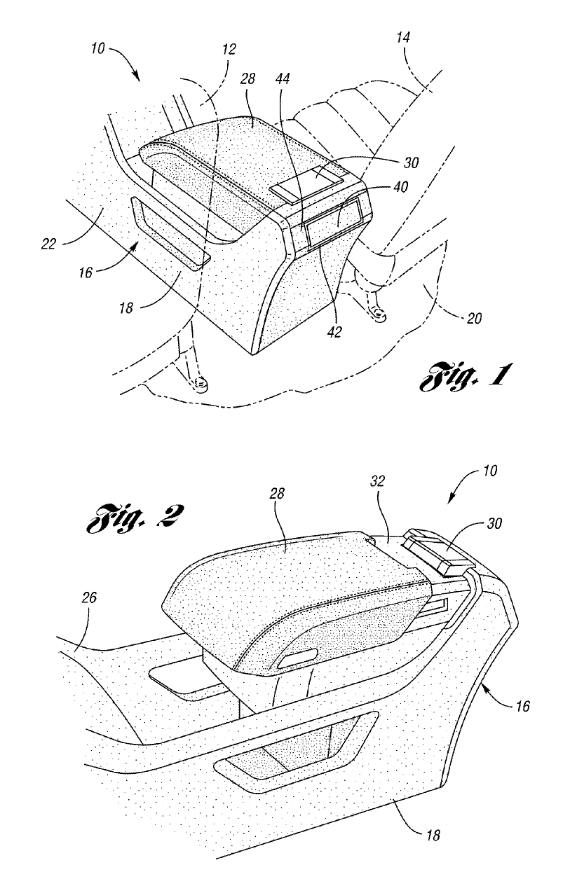

### DETAILED DESCRIPTION OF THE PREFERRED EMBODIMENT(S)

Referring now to the Figures, a console assembly for use in the passenger seating area of a motor vehicle in accordance with the present invention is disclosed. It is understood that the restraint system may be used in either the front or rear passenger seating areas. For purposes of this disclosure, the restraint system will be installed in the front passenger seating area.

In the following description, various operating parameters and components are described for a number of constructed embodiments. These specific parameters and components are included as examples and are not meant to be limiting.

Console assembly 10 disposed between a pair of passenger seats 12, 14 in the passenger compartment of the vehicle. Console assembly 10 includes a console housing 16 having a base 18 configured to secure the console assembly 10 to the floor 20 of the passenger seating area of the vehicle. The base of console housing may also be connected to one or more vehicle seats. A pair of side surfaces 22, 24 extend generally upward from base 18 and are preferably disposed adjacent the pair of passenger seats 12, 14. It is understood that the console housing may be positioned anywhere within the passenger seating area of the vehicle.

Console housing 16 further includes a front surface 26 disposed generally adjacent a dashboard (not shown) or other forward portion of the vehicle and an opposing rear surface 38 accessible by occupants in a rear passenger seating area of the vehicle. The console housing 16 may also include a variety of storage compartments or areas, such as storage bins or cup holders, formed on an external portion of the console housing.

An armrest 28 is pivotally connected to console housing 16 by a hinge 30. Armrest 28 is pivotally connected to the console housing 16 and is positionable between a lowered position disposed at least partially adjacent a top surface 36 of the console housing 16 and a raised position disposed away from the top surface 36 of console housing 16. It should also be understood that the armrest can be easily arranged to pivot about the front, rear or sides of the console housing based on design and aesthetic requirements.

In one aspect of the present invention shown in FIG. 2, armrest 28 is slidably mounted to a receiving portion 32. Receiving portion 32 allows armrest 28 to be adjusted forward and rearward relative to the console housing by the occupants of the passenger seating area. In another aspect of the present invention, the armrest may include a two piece assembly, wherein the lower portion includes a storage area and the upper portion or armrest closeout section is secured adjacent the storage area.

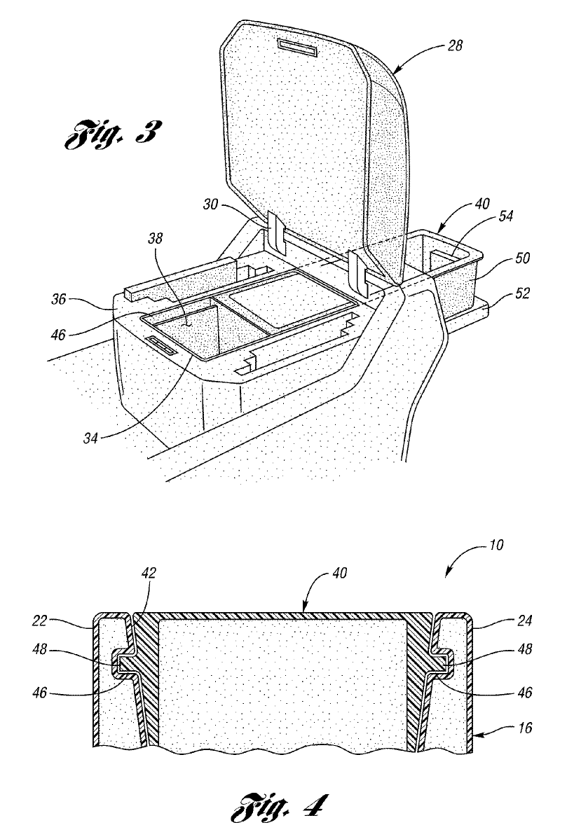

Referring now to FIGS. 3 and 4, armrest 28 extends at least partially over an opening 34 in a top surface 36 in the console housing 16. Opening 34 communicates with a storage area 38 extending below the top surface 36 of the console housing 16. Storage area 38 may include a cavity configured to provide access to one or more storage modules 40 housed therein. Storage module 40 is configured to receive and secure a variety of passenger personal items, such as purses, cell phones or sunglasses. It is also contemplated that vehicle components, such as garage door openers, media components and the like may be positioned within the storage area or cavity.

Console assembly 10 is configured to allow access to the one or more storage modules 40 in console housing by both front and rear seat occupants in the passenger seating area of the vehicle. A channel 42 is provided in a rear surface 44 of console housing 16. Channel 42 communicates with storage area 38 and allows storage module 40 to be adjusted rearward relative to the console housing 16 through channel 42.

In one aspect of the present invention, channel 42 includes a pair of opposing tracks 46 configured to receive a pair of projections 48 extending from an outer surface 50 of storage module 40. In one embodiment of the present invention, opposing tracks are generally U-shaped in cross-section to receive and guide the storage module projections as they travel through the tracks. In another embodiment of the present invention, the opposing tracks are generally L-shaped and configured to receive storage module projections shaped to travel through the L-shaped tracks.

Storage module 40 may include a handle 54 or other gripping surface allowing an occupant to grasp and pull the module from a stowed position generally within the storage area 38 and a deployed position illustrated in FIG. 3. In another aspect of the present invention, a door 52 is mounted adjacent channel 42. Door 52 may be slidably or pivotally connected to the console housing 16 such that the door is movable between a closed position at least partially covering channel 42 and an open position exposing channel 42 and at least partially stored within channel 42. It is contemplated that door 52 may include an appearance surface adapted to match the exterior surface of console housing. Alternatively, the door may include an electronic interface or control panel which provides rear seat occupants access to controls for vehicle components such as the audio/video system or the heating and ventilation system.

In yet another aspect of the present invention, one or more rails are provided on opposing sides of the channel. Rails are configured to receive and guide one or more rollers (not shown) extending from a drawer. The drawer receives the one or more storage modules. In an alternative embodiment of the present invention, rollers are disposed on the storage module, allowing the module to travel through the channel in console housing. Accessability to the one or more storage modules from the rear passenger seating area of the vehicle increases the storage options in a vehicle while decreasing the total number of compartments required in the passenger seating area.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A console assembly for use in a passenger seating area of a vehicle, the console assembly comprising:
a console housing having a base, a front surface, opposing side surfaces, a rear surface and a storage area defined therein;
an armrest adjustable relative to the console housing between a lowered position disposed at least partially adjacent the console housing and a raised position disposed away from the console housing; and
one or more storage modules disposed at least partially within the storage area for receiving one or more items,
wherein the one or more storage modules are positionable between a stowed position and a deployed position extending at least partially through the rear surface of the console housing.

2. The console assembly of claim 1 wherein the console housing is disposed between a pair of front passenger seats in the passenger seating area.

3. The console assembly of claim 1 wherein the console housing further comprises a top surface having an opening formed therein in communication with the storage area.

4. The console assembly of claim 1 wherein the armrest extends at least partially over the opening in the top surface of the console housing in the lowered position.

5. The console assembly of claim 1 wherein the rear surface of the console housing further comprises a channel formed in the rear surface of the console housing in communication with the storage area.

6. The console assembly of claim 1 wherein the channel includes a pair of opposing tracks configured to receive and guide the one or more storage modules through the channel.

7. The console assembly of claim 6 wherein the one or more storage modules include a pair of projections extending from an outer surface of the module to engage the pair of opposing tracks.

8. The console assembly of claim 5 wherein the channel further comprises one or more rails configured to receive and guide the one or more storage modules through the channel.

9. The console assembly of claim 1 further comprising one or more storage compartments formed in an external portion of the console housing.

10. The console assembly of claim 1 wherein the base of the console housing is securable to a floor of the passenger seating area of the vehicle.

11. A console assembly disposed between a pair of passenger seats in a passenger seating area of a vehicle, the console assembly comprising:
a console housing having a base, a front surface, opposing side surfaces, a rear surface, a top surface and a storage area defined therein;
an opening formed in the top surface of the console housing in communication with the storage area;
a channel formed in the rear surface of the console housing in communication with the storage area;
an armrest adjustable relative to the console housing between a lowered position disposed at least partially adjacent an opening in the top surface of the console housing and a raised position disposed away from the console housing; and
one or more storage modules disposed at least partially within the storage area for receiving one or more items,
wherein the one or more storage modules are positionable between a stowed position and a deployed position extending through the rear surface of the console housing.

12. The console assembly of claim 11 wherein the armrest extends at least partially over the opening in the top surface of the console housing in the lowered position.

13. The console assembly of claim 11 wherein the channel includes a pair of opposing tracks configured to receive and guide the one or more storage modules through the channel.

14. The console assembly of claim 13 wherein the one or more storage modules include a pair of projections extending from an outer surface of the module to engage the pair of opposing tracks.

15. The console assembly of claim 11 wherein the channel further comprises one or more rails configured to receive and guide the one or more storage modules through the channel.

16. The console assembly of claim 11 further comprising one or more storage compartments formed in an external portion of the console housing.

17. A console assembly disposed between a pair of passenger seats in a passenger seating area of a vehicle, the console assembly comprising:
a console housing having a base, a front surface, opposing side surfaces, a rear surface, a top surface and a storage area defined therein;
an opening formed in the top surface of the console housing in communication with the storage area;
a channel formed in the rear surface of the console housing in communication with the storage area;
an armrest adjustable relative to the console housing between a lowered position disposed at least partially adjacent an opening in the top surface of the console housing and a raised position disposed away from the console housing; and
a storage module slidably connected to one or more rails in the channel for receiving one or more items positionable between a stowed position and a deployed position extending at least partially through the rear surface of the console housing.

18. The console assembly of claim 11 further comprising one or more storage compartments formed in an external portion of the console housing.
